(19) United States
(12) Patent Application Publication
(10) Pub. No.: US 2015/0307262 A1
(43) Pub. Date: Oct. 29, 2015

(54) PACKET FOR SMOKING ARTICLES AND METHOD FOR MAKING THE PACKET

(71) Applicant: G.D S.P.A., Bologna (IT)

(72) Inventors: Marco GHINI, Monte San Pietro (Bologna) (IT); Stefano NEGRINI, Calderara di Reno (Bologna) (IT)

(21) Appl. No.: 14/443,606

(22) PCT Filed: Dec. 19, 2013
(86) PCT No.: PCT/IB2013/061126

§ 371 Date: May 18, 2015

(30) Foreign Application Priority Data
Dec. 20, 2012 (IT) BO2012A000688

(51) Int. Cl. B65D 85/10; B65D 5/02; B31F 1/00; B65D 5/66; B65D 5/44; A24F 15/00; B65D 5/42

(52) U.S. Cl. CPC B65D 85/1045; A24F 15/00; B65D 5/02; B65D 5/4266; B65D 5/66; B65D 5/443; B31F 1/0009

(57) ABSTRACT

A packet for smoking articles includes an outer container, substantially shaped as a parallelepiped having an open top end and a hinged lid, which can rotate between positions for opening and closing the, open top end and which is defined by a rear wail a front wall, two side walls and a top wall. One bottom edge of the front wall is integral with a reinforcement wall which is folded by 180° around the edge and which is positioned in abutment against the inside surface of the front wall. The reinforcement wail includes at least two panels which are integral with each other in pairs along folding lines of weakness and which can be inclined relative to each other around the lines of weakness to be positioned in abutment, at least, against the inside surface of the lid at the top wall.

### TECHNICAL FIELD

This invention relates to a packet for smoking articles and to a method for making the packet.

Hereinafter in this description, reference is made to smoking articles consisting of cigarettes, without thereby restricting the scope of the invention.

### BACKGROUND ART

Hard, hinged-lid packets for cigarettes are currently the cigarette packets of the most widespread type on the market because they are simple to make, easy and practical to use and provide good mechanical protection for the cigarettes they contain.

A hard, hinged-lid packet for cigarettes comprises an inner wrapper, usually made of metallized paper, placed around a group of cigarettes, and a hard outer container which receives the inner wrapper. The outer container comprises an open top container body with upward facing concavity and which receives the group of cigarettes placed in the inner wrapper, and a lid with downward facing concavity and which is joined to the container body along a hinge allowing it to rotate relative to the container body between an open position and a closed position. Normally, there is a frame, which is folded into a U shape and connected to the inside of the container body in such a way as to protrude partly from the open top end of the container body and to engage a corresponding inside surface of the lid when the lid is in the closed position.

Typically, the outside surface of a packet is printed to show the cigarette brand name, cigarette description, compulsory health warnings and other consumer related information and advertising addressing smokers. In some cases, cigarette packet manufacturers are required to provide their customers with so much information that it is difficult to print it all legibly on the outside surface of a packet, since the outside of the packet is relatively limited in size and largely occupied by the legally compulsory health warnings.

For this reason, it is common practice to accompany each cigarette packet with a coupon which is typically folded in concertina fashion and inserted into the packet or fixed to the outside of the packet by one or more glue points,

A hard cigarette packet with a coupon of the type described above is expensive to make because the packing machine must be provided with a further station for feeding the coupon material. Also, a coupon separate from the packet is very unlikely to be read and is more of a nuisance for the smoker, with the result that the smoker usually throws it away the first time the packet is opened.

Patent EP1614641B1 suggests printing on the inside of the lid of a hinged-lid packet so that the print is visible to the smoker each time the packet is opened by the smoker. According to this patent, the information is printed on the back of the blank used to make the hard outer container, that is to say on the face of the blank opposite to that which will constitute the outside surface of the container.

This method is not free of disadvantages, however, because it involves two distinct printing operations on the two opposite faces of the blanks, which translates as higher costs due to the need to provide the packing machine with two separate printing apparatuses.

Moreover, since the back of the blank is never lacquered (unlike the front, which always is), because the inside surface of the packet is not as exposed to the smoker's view, the information which is supposed to attract the smoker's attention is in fact printed on a surface that is not very attractive.

### DISCLOSURE OF THE INVENTION

The aim of this invention is to provide a packet for smoking articles and a method for making the packet which are free of the disadvantages described above with reference to the prior art.

The invention accordingly provides a packet for smoking articles and a method for making the packet as described in the appended claims.

### BRIEF DESCRIPTION OF THE DRAWINGS

The invention is described below with reference to the accompanying drawings, which illustrate a non-limiting embodiment of it, and in which:

FIG. 1 is a plan view of a blank used to make the packet according to this invention;

FIG. 1A is a front perspective view of a hard cigarette packet made according to this invention, in an open configuration; and

FIGS. 2-7 are six schematic perspective views showing the blank of FIG. 1 in six different successive steps of folding to make the packet of FIG. 1A.

### DETAILED DESCRIPTION OF PREFERRED EMBODIMENTS OF THE INVENTION

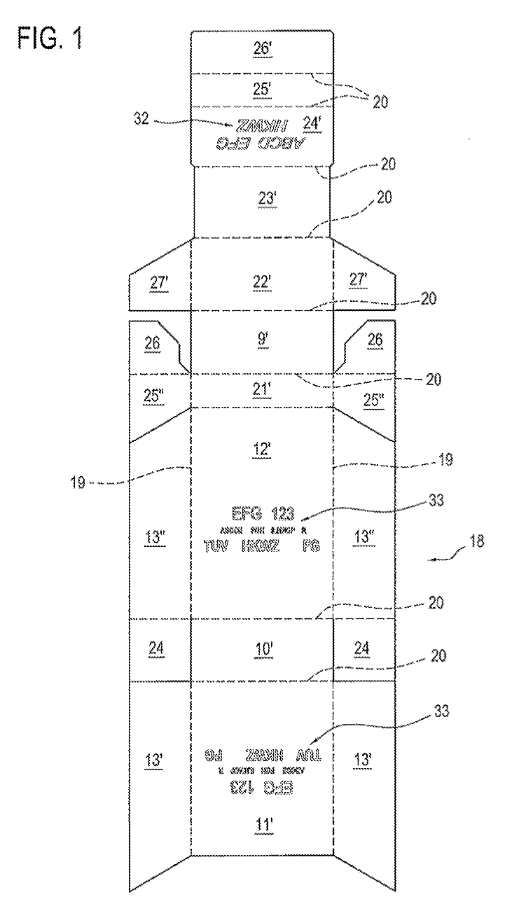

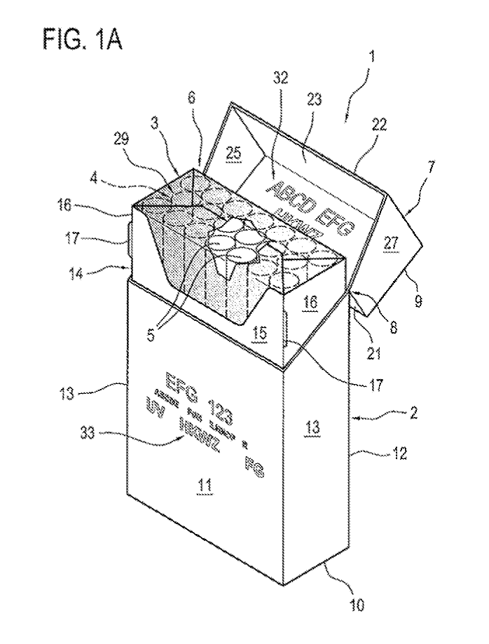

The numeral 1 in FIG. 1A denotes in its entirety a hard, hinged-lid cigarette packet comprising an outer container 2 made of stiff card or paperboard and an inner wrapper 3 housed inside the container 2. The inner wrapper 3 encloses a group 4 of cigarettes 5 and is made, for example, of metallized paper. In the example illustrated, the group 4 is substantially in the shape of a parallelepiped.

The outer container 2 has an open top end 6 and is provided with a hollow lid 7 joined to the container 2 along a hinge 8 allowing it to rotate relative to the container 2 itself between an open position (illustrated in FIG. 1A) and a closed position where the open top end 6 is closed.

The lid 7, when it is in the closed position, gives the outer container 2 the shape of a rectangular parallelepiped defined by a top wall 9 and a bottom wall 10 which are parallel and opposite to each other, two large side walls 11 and 12 which are parallel and opposite to each other and two small side walls 13 which are parallel and opposite to each other. More specifically, one of the large side walls, labelled 11, constitutes the front wall of the outer container 2, whilst the other large side wall, labelled 12, defines the rear wall of the outer container 2.

The packet 1 also comprises an inner frame 14, which is folded into a U shape and fixed (normally by gluing) to the inside of the outer container 2 in such a way as to protrude partly from the open top end 6 and to engage a corresponding inside surface of the lid 7 when the lid 7 is in the aforementioned closed position. The inner frame 14 is usually made of stiff card or paperboard and comprises a front wall 15 in contact with the front wall 11 of the outer container 2 and two side walls 16 located on opposite sides of the front wall 15 and in contact with the small side walls 13 of the outer container 2. When the packet 1 is closed, the function of the inner frame 14 is to keep the lid 7 in the closed position, making it necessary to apply a certain amount of force to open the lid 7. For this purpose, the inner frame 14 preferably has a pair of protuberances 17 which protrude outwards to impinge with a certain force against the lid 7 when the lid 7 is in the closed position.

As illustrated, in particular in FIG. 1, the packet 1 of FIG. 1A is made from a flat blank 18 which has a substantially rectangular, elongate shape and whose parts are, where possible, denoted by primed reference numerals which are the same as the reference numerals denoting the corresponding parts of the hard cigarette packet 1.

The blank 18 has two longitudinal lines of weakness 19 and a plurality of transverse lines of weakness 20 which, between the pair of longitudinal lines of weakness 19 define a panel 11′ which forms the front wall 11 of the outer container 2, a panel 10′ which forms the bottom wall 10 of the outer container 2, a panel 12′ which forms the rear wall 12 of the outer container 2, a panel 21′ which forms the rear wall 21 of the lid 7 (the hinge 8 coincides with the transverse line of weakness 20), a panel 9′ which forms the top wall 9 of the lid 7, a panel 22′ which forms the front wall 22 of the lid 7, an inside panel 23′ defining a part of a reinforcement wall 23 of the front wall 22 of the lid 7, and another three, substantially rectangular panels 24′, 25′ and 26′ connected to each other in that order along transverse lines of weakness 20 and defining further respective parts of the reinforcement wall 23 of the top wall 9 and rear wall 21 of the lid 7 and an upper portion of the rear wall 12 of the outer container 2. More generally speaking, and as will become clearer as this description continues, the blank 18 comprises at least two of the panels 23′, 24′, 25′, 26′, and these panels 23′, 24′, 25′, 26′ are joined to each other in pairs along pairs of folding lines of weakness 20 and can be inclined to each other around the lines of weakness 20 to be positioned in abutment, at least, against the inside surface of the lid 7 at the top wall 9 of the selfsame lid 7.

The panel 11′ bears a pair of side flaps 13′ which form an outer portion of the side walls 13 of the outer container 2, are located on opposite sides of the panel 11′ and are separated from the panel 11′ itself by the longitudinal lines of weakness 19.

The panel 12′ bears a pair of side flaps 13″ which form an inner portion of the side walls 13 of the outer container 2, are located on opposite sides of the panel 12′ and are separated from the panel 12′ itself by the longitudinal lines of weakness 19, Each flap 13″ is connected along a transverse line of weakness 20 to an inner reinforcement tongue 24 for the bottom wall 10 of the outer container 2.

The panel 21′ bears a pair of side flaps 25′ which form an inner portion of the side walls 25 of the lid 7, are located on opposite sides of the panel 21′ and are separated from the panel 21′ itself by the longitudinal lines of weakness 19. Each flap 25′ is connected along a transverse line of weakness 20 to an inner reinforcement tongue 26 for the top wail 9 of the lid 7.

The panel 22′ bears a pair of side flaps 27′ which form an outer portion of the side walls 27 of the lid 7, are located on opposite sides of the panel 22′ and are separated from the panel 22′ itself by the longitudinal lines of weakness 19.

The above mentioned inner frame 14 is joined to the outer container 2 by gluing at the panel 11′ and flaps 13′ while the outer container 2 itself is being formed.

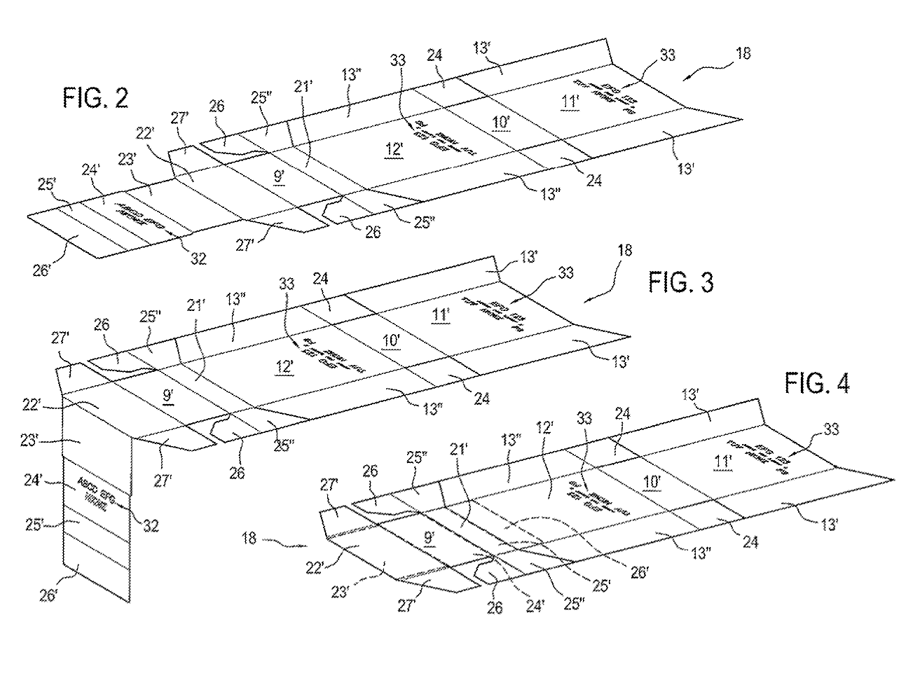

The steps in the making of a packet 1 are illustrated in FIGS. 2-7 in chronological order, starting from a blank 18 shown in FIG. 2 laid out on a flat horizontal surface (by way of an example) with the surface that will form the outside surface of the packet 1 facing upwards.

As shown in FIGS. 3-7, first the panel 23′ of the blank 18 is folded, together with the panels 24′, 25′ and 26′, by 90° relative to the body of the blank 18 about a transverse line of weakness 20 which separates it from the panel 22′ (FIG. 3), by rotation directed downwardly in FIG. 3. The set comprising the panels 23′, 24′, 25′ and 26′ is then folded by a further 90° (making a total of 180°) relative to the body of the blank 18 about the transverse line of weakness 20 which separates it from the panel 22′ until adhering against the surface of the blank 18 which, in FIG. 4, is on the underside. Suitable gluing devices, not illustrated, then apply spots of glue on the blank 18 according to the typical pattern for hinged-lid cigarette packets, without applying glue to the panels 23′, 24′, 25′ and 26′.

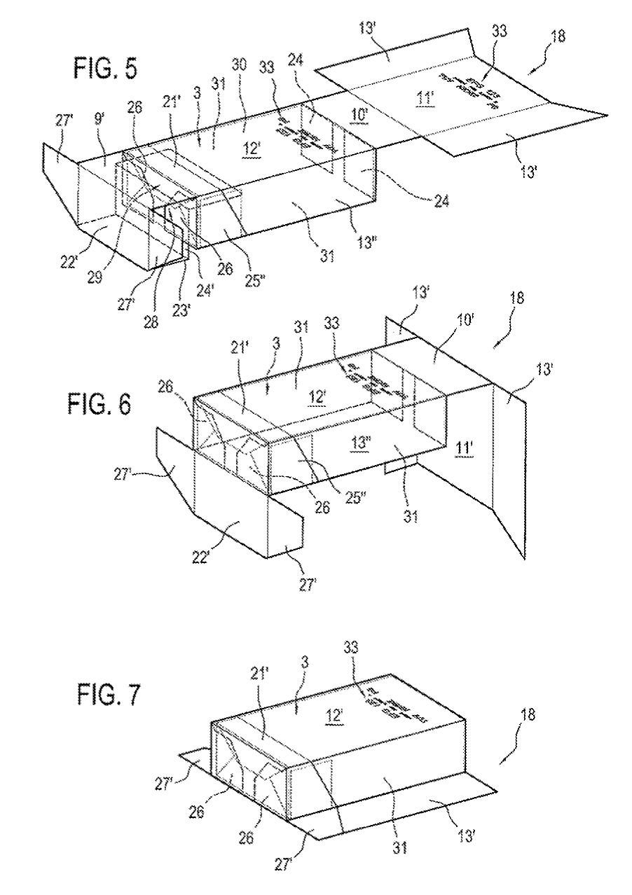

An inner wrapper 3 enclosing a group 4 of cigarettes 5 is then brought with its large rear surface into contact with the surface of the panels 12′ and 21 which will be on the inside of the packet 1, and the flaps 13″ and 25″ on both sides of the blank 18 are folded by 90° about the longitudinal lines 19 adjacent thereto (downwardly in FIG. 5, by way of example) to adhere to respective small side surfaces of the selfsame wrapper 3. The folding of the flaps 13″ and 25″ is usually carried out while the inner wrapper 3 and part of the blank 18 are entering a housing of a wrapping wheel not illustrated.

At the same time, as shown in FIG. 5, the panel 22′, together with the flaps 27′ connected thereto, is folded downwardly by 90° about the transverse line 20 which joins it to the panel 9′, so that the set comprising the panels 9′, 22′, 23′ and 24′ takes on the shape of a box defining inside it a chamber 28 substantially having the shape of a parallelepiped open at the opposite flanks and delimited by the panels 9′, 22′ and 23′ and by the panel 24′ which is in contact with the top end surface 29 of the inner wrapper 3. The tongues 26 are then folded by 90° about the transverse line 20 which separates them from the flaps 25, in such a way that they are tucked into the chamber 28 and made to adhere to the panel 24′ adjacent to the top end surface 29 of the inner wrapper 3. To facilitate tucking the tongues 26 into the chamber 28, without crumpling, the tongues 26 are much smaller than the free surface between the flaps 25″ and 27′ adjacent to them.

The tongues 24 are also folded by 90° about the transverse line 20 which separates them from the flaps 13″ adjacent to them and are brought into contact with the bottom end surface 29 of the inner wrapper 3.

The set comprising the panels 9′, 22′ and 23′ is then pushed towards the top end surface 29 of the inner wrapper 3, by causing the panel 9′ to rotate by 90° (downwardly in FIG. 6) about the transverse line 20 which separates it from the panel 21′, in such a way as to make the panels 9′ and 24′ and the panels 22′ and 23′ move into abutment against each other, eliminating the space inside the chamber 28. The flaps 26 thus remain trapped between the panels 9′ and 24′ without having to glue them to one of the panels 9′, 24 to hold them in place. If desired, however, gluing is possible and, in that case, it would be preferable for the adhesive to be applied to the flaps 26 rather than to one (or both) of the panels 9′, 24. The panels 11′ and 13′ are folded about the transverse line 20 which separates the panel 11′ from the panel 10′, so as to move gradually into abutment, respectively, against the lower portion of the front wall 30 of the inner wrapper 3 and the front wall 15 of the inner frame 14 and against the lower portions of the side walls 31 of the inner wrapper 3 and of the side walls 16 of the inner frame 14.

In the meantime, the reciprocally adjacent panels 22′ and 23′ are folded by 90° about the transverse lines 20 which connect them to the panels 9′ and 24, respectively, in order to bring the panel 23′ into contact with the upper portion of the front wall 30 of the inner wrapper 3 and with the upper portion of the front wall 15 of the inner frame 14 (FIG. 7).

To complete the packet 1, the tongues 27′ are then folded by 90° about the longitudinal lines 19 which partly delimit them (this step is not illustrated because it simply leads to obtainment of the packet 1 shown in FIG. 1A), and are placed over the adjacent flaps 25″, and the panels 13′ are folded by 90° about the same longitudinal lines 19 and are placed over corresponding flaps 13″.

According to the aims of this invention, the packet 1 made in the manner described above may be provided with further printing 32 on the inside of the lid 7, in addition to the printing 33 on the outside surface of the packet 1 and this printing 32 is also on the lacquered surface of the blank 18 which defines the outside surface of the packet 1.

It should be noted that in the finished packet 1, the panels 25′ and 26′ are located between the inner wrapper 3 and the inside surface of the outer container 2, which they form part of, but they are preferably not glued to the panels 21′ and 12′ adjacent thereto, so that they can make small movements each time the lid 7 is opened, thereby preventing the outer container 2 from going out of shape.

It should also be noted that in alternative embodiments, not illustrated, of the packet 1, at least some of the longitudinal and/or transverse edges of the packet 1 might be rounded or chamfered, instead of being sharp edges.

Lastly, it should be noted that the packet 1 for smoking articles described above might also be made, using the solution forming the object of this invention, to contain cigarette packets instead of elongate smoking articles such as the cigarettes 5.

1. A packet for smoking articles comprising an outer container, which is substantially in the shape of a parallelepiped and is provided with a rear wall a front wall, two side walls, a bottom wall and an open top end; the outer container having hinged to it a lid, which can rotate between a position for opening and a position for closing the open top end and which is defined by a rear wall a front wall, two side walls and a top wall; one bottom edge of the front wall of the lid being integral with a reinforcement wall which is folded by 180° around the edge and which is positioned in abutment against the inside surface of the front wall of the lid; the packet wherein the reinforcement wall comprises at least two panels (23′, 24′, 25′, 26′) which are integral with each other in pairs along folding lines of weakness and which can be inclined relative to each other around the lines of weakness to be positioned in abutment, at least, against the inside surface of the lid at the top wall of the lid, the reinforcement wall also comprises at least one panel (23′, 24′, 25′, 26′) positioned in abutment against the inside surface of the outer container at the rear wall of the outer container.

2. The packet according to claim 1, where the upper edges of the side walls of the outer container are integral with respective tongues along folding lines of weakness; wherein the tongues are folded around the respective folding lines of weakness in such a way as to be tucked between the top wall of the lid and one of the panels (23′, 24′, 25′, 26′) forming part of the reinforcement wall.

3. The packet according to claim 1, wherein the outer container has an inner frame, which is folded into a U shape and connected to the inside of the outer container in such a way as to protrude partly from the open top end and to engage a corresponding inside surface of the lid when the lid is in the closed position.

4. The packet according to claim 1, wherein the outer container is made from a flat blank having two longitudinal lines of weakness and a plurality of transverse lines of weakness which define, between the lines of weakness:
a first panel (11′) which forms the front wall of the outer container;
a second panel (10′) which forms the bottom wall of the outer container;
a third panel (12′) which forms the rear wall of the outer container; a fourth panel (21′) which forms the rear wall of the lid;
a fifth panel (9′) which forms the top wall of the lid;
a sixth panel (22′) which forms the front wall of the lid;
a first reinforcement panel (23′) for the front wall the lid; and a second reinforcement panel (24′) for the top wall of the lid; the first and second reinforcement panels (23′, 24′) forming part of the reinforcement wall.

5. The packet according to claim 1, wherein it further comprises at least one further reinforcement panel (25′, 26′) for the upper portion of the rear wall of the outer container; an edge of the second reinforcement panel (24′) being integral with an edge of one of the at least one further reinforcement panel (25′, 26′).

6. The packet according to claim 1, wherein the first panel (11′) has a pair of first flaps (13′) which form an outer portion of the side walls of the outer container, are located on opposite sides of the first panel (11′) and are separated from the first panel (11′) itself by the longitudinal lines of weakness; the third panel (12′) has a pair of second flaps (13″) which form an inner portion of the side walls of the outer container, are located on opposite sides of the third panel (12′) and are separated from the third panel (12′) itself by the longitudinal lines of weakness; the fourth panel (21′) has a pair of third flaps (25″) which form an inner portion of the side walls of the lid, are located on opposite sides of the fourth panel (21′) and are separated from the fourth panel (21′) itself by the longitudinal lines of weakness; and the sixth panel (22′) has a pair of fourth flaps (27′) which form an outer portion of the side walls of the lid, are located on opposite sides of the sixth panel (22′) and are separated from the sixth panel (22′) itself by the longitudinal lines of weakness.

7. The cigarette packet according to claim 1, wherein each second flap (13″) is connected along a transverse line of weakness to a second inner reinforcement tongue for the bottom wall (10′) of the outer container; each third flap (25′) is connected along a transverse line of weakness to a third inner reinforcement tongue for the top wall (9′) of the lid.

8. A method for producing a packet for smoking articles made according to claim 1, the packet comprising an outer container, which is substantially in the shape of a parallelepiped and is provided with a rear wall, a front wall, two side walls, a bottom wall and an open top end; the outer container having hinged to it a lid, which can rotate between a position for opening and a position for closing the open top end and which is defined by a rear wall a front wall, two side walls and a top wall; and one bottom edge of the front wall of the lid being integral with a reinforcement wall which is folded by 180° around the edge and which is positioned in abutment against the inside surface of the front wall of the lid; characterized in that, with the reinforcement wall comprising at least two panels (23′, 24′) which are integral with each other in pairs along folding lines of weakness and which can be inclined relative to each other around the lines of weakness to be positioned in abutment, at least, against the inside surface of the lid at the top wall of the lid, and with the upper edges of the side walls of the outer container being integral with respective tongues (25″) along folding lines of weakness, it comprises the step of folding the tongues (25″) around the respective folding lines of weakness in such a way as to be tucked between the top wall of the lid and one of the panels (23′, 24′) forming part of the reinforcement wall.
